(19) United States
(12) Patent Application Publication
(10) Pub. No.: US 2025/0382180 A1
(43) Pub. Date: Dec. 18, 2025

(54) METHOD OF MANUFACTURING CARBON NANOTUBE-CARBON NANOFIBER COMPOSITE AND CARBON NANOTUBE-CARBON NANOFIBER COMPOSITE MANUFACTURED BY THE SAME

(71) Applicant: NATIONAL KOREA MARITIME & OCEAN UNIVERSITY R&DB FOUNDATION, Busan (KR)

(72) Inventors: Jun KANG, Busan (KR); Se Hwa HONG, Busan (KR)

(73) Assignee: NATIONAL KOREA MARITIME & OCEAN UNIVERSITY R&DB FOUNDATION, Busan (KR)

(21) Appl. No.: 19/198,158

(22) Filed: May 5, 2025

(30) Foreign Application Priority Data
Jun. 18, 2024 (KR) 10-2024-0079255

(51) Int. Cl. C01B 32/162; B82Y 30/00; B82Y 40/00; C01B 32/18

(52) U.S. Cl. CPC C01B 32/162; C01B 32/18; B82Y 30/00; B82Y 40/00; C01P 2002/82; C01P 2002/85; C01P 2002/89; C01P 2004/03

(57) ABSTRACT

A method of manufacturing a carbon nanotube-carbon nanofiber composite, includes preparing a spinning solution comprising an alkali metal precursor and a carbon-containing polymer; electrospinning the spinning solution to manufacture carbon-containing polymer nanofibers having the alkali metal precursor bound to a surface; heat-treating the carbon-containing polymer nanofibers to manufacture carbon nanofibers having the alkali metal precursor bound to a surface; and heat-treating the carbon nanofibers while supplying a carbon source to manufacture a carbon nanotube-carbon nanofiber composite having carbon nanotubes bound to a surface.

### CROSS-REFERENCE TO RELATED PATENT APPLICATION

This application claims priority to Korean Patent Application No. 10-2024-0079255 (filed on Jun. 18, 2024), which is hereby incorporated reference in its entirety.

### BACKGROUND

Embodiments of the present disclosure relate to a method of manufacturing a carbon nanotube-carbon nanofiber composite and a carbon nanotube-carbon nanofiber composite manufactured by the same.

Carbon nanofibers refer to fibrous carbon materials with a carbon element mass content of 90% or more and a diameter of 1 μm or less. Carbon nanofibers have high mechanical properties, excellent thermal/electrical conductivity, and chemical stability due to the mixed sp, sp², and sp³ bonds between carbon atoms, and based on these properties, they have recently been used as energy storage and conversion materials such as electrode materials for secondary batteries and supercapacitors, and catalyst supports for fuel cells. However, they have the disadvantage of having a large contact resistance because the physical contact between nanofibers is insufficient, and lower electrical conductivity than carbon nanotubes due to the mixed sp, sp², and sp³ bonds.

Carbon nanotubes are materials in which six carbon atoms form a tube shape by forming sp² bonds, and refer to carbon materials with a tube diameter of several to several tens of nm. While the tube diameter is nano-sized, the tube length grows from several μm to several mm, so it has the characteristic of having a very large aspect ratio. In addition, it is being applied as a material that may replace existing materials in the field of nanocomposite material manufacturing due to its excellent mechanical, electrical, and thermal properties.

For this reason, a composite material formed with carbon nanotubes on carbon nanofibers may combine the advantages of both, and may expand excellent electrical and mechanical properties not only in the longitudinal direction of the carbon nanofibers but also in the direction perpendicular thereto, thereby serving as an ideal two-dimensional fiber-reinforced component. Furthermore, since such a composite material may utilize the relatively large surface area of the carbon nanotubes, a substantial expansion of the bonding area is possible, and since functional groups may be introduced into the carbon nanotubes, it is expected that compatibility with polymers of fiber-reinforced materials the be improved, and since the mechanical strength is also expected to be outstanding, it is expected to make a great contribution to industrial fields that require high-performance composite materials, and based on these properties, its use as a conductive material for secondary batteries has been greatly expanded recently.

However, carbon nanotubes exist in a nanoscale powder state, and it is difficult to utilize the excellent physical properties of the nanotubes due to the coagulation caused by the van der Waals force between the tubes. Therefore, unless utilized in a stably dispersed form in a solvent, there is a disadvantage in that its utility is greatly reduced. In addition, in order for composite materials of carbon nanotubes and carbon nanofibers to function properly, the bonding strength between the two must be excellent, but there is a problem that this is not the case.

Composite materials of carbon nanotubes and carbon nanofibers up to now have presented solutions to the problem of dispersing carbon nanotubes in polymers, but there are problems in that the bonding strength between carbon nanotubes and carbon nanofibers is weak, and since the carbon nanotubes are not aligned, the mechanical strength is rather weak when fabricated into a composite material.

In particular, since most non-alkali metal catalysts such as iron (Fe), nickel (Ni), cobalt (Co), and palladium (Pd) are used, numerous non-alkali metal catalyst particles remain as impurities in the carbon nanotubes after being synthesized into a composite material. In order to remove these non-alkali metal catalyst particles, high-concentration acid treatment is required, but since the non-alkali metal catalyst particles are not completely removed with a single acid treatment, there is the inconvenience of having to perform the treatment consecutively multiple times, and since washing water is required for each acid treatment, there is a problem that additional environmental costs are incurred, and due to this, it is difficult to mass-produce composite materials of carbon nanotubes and carbon nanofibers.

Through research, the inventors of the present disclosure have developed a method of manufacturing a new composite material capable of growing carbon nanotubes on carbon nanofibers departing from the existing composite materials of carbon nanotubes and carbon nanofibers, as described in Korean Patent No. 10-2224146. In the prior art, in order to grow carbon nanotubes on carbon nanofibers, a quartz tube was positioned centrally inside an electric heater, and the temperature inside the quartz tube was maintained at 700° C., and ethanol was heated and the generated ethanol vapor was supplied into the quartz tube at 50 sccm for 15 minutes through nitrogen gas bubbling. However, in the prior art, the diameter of the carbon nanofibers was 250 to 2000 nm, the diameter of the carbon nanotubes was 50 to 70 nm, and the length of the carbon nanotubes was 200 to 500 nm, so the thickness (diameter) of the carbon nanofibers was not uniform, and the density and length of the growing carbon nanotubes also varied, and there was difficulty in controlling the length and detailed density of the carbon nanotubes.

Accordingly, the inventors of the present disclosure have developed a method of manufacturing a carbon nanotube-carbon nanofiber composite in which the length and density of the carbon nanotubes are controlled and a uniform structure is formed by specifying the steps of manufacturing a carbon nanotube-carbon nanofiber composite and controlling the conditions, and have completed the present disclosure.
Prior-Art Documents: Korean Patent No. 10-0829001, Korean Patent No. 10-2224146

### SUMMARY

The present disclosure was invented to solve the above problems, and provides a method of manufacturing a carbon nanotube-carbon nanofiber composite.

Further, a carbon nanotube-carbon nanofiber composite manufactured by the above manufacturing method is provided.

In order to solve the above technical problems, the present disclosure provides a method of manufacturing a carbon nanotube-carbon nanofiber composite, the method including:
a first step of preparing a spinning solution including an alkali metal precursor and a carbon-containing polymer;
a second step of electrospinning the spinning solution to manufacture carbon-containing polymer nanofibers;
a third step of heat-treating the carbon-containing polymer nanofibers to manufacture carbon nanofibers having the alkali metal precursor bound to a surface; and
a fourth step of heat-treating the carbon nanofibers while supplying a carbon source to manufacture a carbon nanotube-carbon nanofiber composite having carbon nanotubes bound to a surface,
wherein the fourth step includes:
a carbon nanotube seed formation step of supplying the carbon source to the carbon nanofibers while heating in an inert gas atmosphere so that the alkali metal precursor is activated as an alkali metal nanocatalyst, and forming a carbon nanotube seed for growing into a carbon nanotube as the carbon source is bound to the surface of the carbon nanofibers by the nanocatalyst;
a first carbon nanotube growth step of resupplying the carbon source to the carbon nanofibers while heating in an inert gas atmosphere after the carbon nanotube seed formation step to grow carbon nanotubes on the surface of the carbon nanofibers;
a nanocatalyst activation step of supplying hydrogen gas after the first carbon nanotube growth step and further activating the nanocatalyst through reduction of the alkali metal nanocatalyst by the hydrogen gas supply; and
a second carbon nanotube growth step of resupplying the carbon source in an inert gas atmosphere after the nanocatalyst activation step to further grow carbon nanotubes,
thereby manufacturing a carbon nanotube-carbon nanofiber composite having 80 to 120 carbon nanotubes per 1 μm² of the carbon nanofibers on the surface of the carbon nanotube-carbon nanofiber composite.

Further, in order to solve the above technical problems, the present disclosure provides a method of manufacturing a branched fine carbon nanofiber-carbon nanofiber composite, the method including:
a first step of preparing a spinning solution including an alkali metal precursor and a carbon-containing polymer;
a second step of electrospinning the spinning solution to manufacture carbon-containing polymer nanofibers having the alkali metal precursor bound to a surface;
a third step of heat-treating the carbon-containing polymer nanofibers to manufacture carbon nanofibers having the alkali metal precursor bound to a surface; and
a fourth step of heat-treating the carbon nanofibers while supplying a carbon source to manufacture a branched fine carbon nanofiber-carbon nanofiber composite having branched fine carbon nanofibers bound to a surface,
wherein the fourth step includes:
a branched fine carbon nanofiber seed formation step of supplying the carbon source to the carbon nanofibers while heating in an inert gas atmosphere so that the alkali metal precursor is activated as an alkali metal nanocatalyst, and forming a branched fine carbon nanofiber seed for growing into branched fine carbon nanofibers as the carbon source is bound to the surface of the carbon nanofibers by the nanocatalyst;
a first branched fine carbon nanofiber growth step of resupplying the carbon source to the carbon nanofibers while heating in an inert gas atmosphere after the branched fine carbon nanofiber seed formation step to grow branched fine carbon nanofibers on the surface of the carbon nanofibers;
a nanocatalyst activation step of supplying hydrogen gas after the first branched fine carbon nanofiber growth step and further activating the nanocatalyst through reduction of the alkali metal nanocatalyst by the hydrogen gas supply; and
a second branched fine carbon nanofiber growth step of resupplying the carbon source in an inert gas atmosphere after the nanocatalyst activation step to further grow branched fine carbon nanofibers,
thereby manufacturing a branched fine carbon nanofiber-carbon nanofiber composite having 80 to 120 branched fine carbon nanofibers per 1 μm² of the carbon nanofibers on the surface of the branched fine carbon nanofiber-carbon nanofiber composite.

A manufacturing method of the present disclosure by the means for solving the above problems may easily grow carbon nanotubes from the surface of carbon nanofibers by simply manufacturing carbon nanofibers having an alkali metal precursor bonded to the surface through electrospinning, carbonizing, and then supplying a carbon source and performing heat treatment, thereby enabling mass production of carbon nanotube-carbon nanofiber composites. Furthermore, by specifying the step of manufacturing the carbon nanotube-carbon nanofiber composite and controlling the conditions, there is an effect of manufacturing a carbon nanotube-carbon nanofiber composite in which the length and density of the carbon nanotubes are controlled and a uniform structure is formed.

In addition, since the carbon nanotube-carbon nanofiber composite manufactured by the manufacturing method of the present disclosure is manufactured using an alkali metal-based catalyst rather than a transition metal-based catalyst, the catalyst particles dissolve in water and may be easily removed, so that after the synthesis of the metal-free carbon nanotube-carbon nanofiber composite is completed, there is no need to go through a cleaning process such as acid treatment, thereby reducing environmental costs. In addition, carbon nanotubes are grown from carbon nanofibers using a nanocatalyst, and the high bonding strength between the carbon nanofibers and carbon nanotubes prevents separation of the carbon nanofibers and carbon nanotubes, resulting in excellent durability.

### BRIEF DESCRIPTION OF THE DRAWINGS

FIG. 1 illustrates a step of manufacturing carbon nanofibers according to an embodiment of the present disclosure.

FIG. 2 is a graph illustrating conditions of a carbon nanofiber stabilization and carbonization step according to an embodiment of the present disclosure.

FIG. 3 is an SEM image of carbon nanofibers, for each carbon-containing polymer concentration, manufactured according to an embodiment of the present disclosure.

FIG. 4 is an SEM image of a carbon nanofiber-carbon nanotube composite, for each catalyst precursor concentration, manufactured according to an embodiment of the present disclosure.

FIG. 5 is an SEM image of a carbon nanofiber-carbon nanotube composite, for each carbon source, manufactured according to an embodiment of the present disclosure.

FIG. 6 is an SEM image of a carbon nanofiber-carbon nanotube composite manufactured by varying distance between a gas inlet and carbon nanotube fibers according to an embodiment of the present disclosure.

FIG. 7 is an SEM image of a carbon nanofiber-carbon nanotube composite manufactured by varying gas injection time according to an embodiment of the present disclosure.

FIG. 8 is an SEM image of a carbon nanofiber-carbon nanotube composite manufactured by varying gas flow rate according to an embodiment of the present disclosure.

FIG. 9 is an image of a shape and a microstructure of a carbon nanofiber-carbon nanotube composite manufactured according to an embodiment of the present disclosure.

FIG. 10 is a nitrogen adsorption/desorption isotherm curve of a carbon nanofiber-carbon nanotube composite manufactured according to an embodiment of the present disclosure.

FIG. 11 is a pore distribution curve of a carbon nanofiber-carbon nanotube composite manufactured according to an embodiment of the present disclosure.

FIG. 12 illustrates ToF-SIMS analysis results of a carbon nanofiber-carbon nanotube composite manufactured according to an embodiment of the present disclosure.

FIG. 13 illustrates XPS analysis results of a carbon nanofiber-carbon nanotube composite manufactured according to an embodiment of the present disclosure.

FIG. 14 is a carbon bonding peak of a carbon nanofiber-carbon nanotube composite manufactured according to an embodiment of the present disclosure.

FIG. 15 is a Raman spectrum of a carbon nanofiber-carbon nanotube composite manufactured according to an embodiment of the present disclosure.

FIG. 16 is a first cycle charge/discharge curve of a lithium ion battery anode material including a carbon nanofiber-carbon nanotube composite manufactured according to an embodiment of the present disclosure.

FIG. 17 illustrates ultra-high rate performance evaluation results of a lithium ion battery anode material including a carbon nanofiber-carbon nanotube composite manufactured according to an embodiment of the present disclosure.

FIG. 18 is a discharge capacity graph at a charge/discharge rate of 2 C of a lithium ion battery anode material including a carbon nanofiber-carbon nanotube composite manufactured according to an embodiment of the present disclosure.

### DETAILED DESCRIPTION

The present disclosure may be modified in various ways and may take various forms, and thus the embodiments are described in detail in the text. However, this is not intended to limit the present disclosure to a specific disclosed form, but should be understood to include all modifications, equivalents, or substitutes included in the spirit and technical scope of the present disclosure.

Throughout the specification, when a part is said to “comprise” or “include” a component, this does not mean that other components are excluded, but that other components may be included, unless specifically stated otherwise.

Unless otherwise defined, all terms used herein, including technical or scientific terms, have the same meaning as commonly understood by a person skilled in the art to which the present disclosure pertains. Terms defined in commonly used dictionaries should be interpreted as having a meaning consistent with the meaning they have in the context of the relevant technology, and are not to be interpreted in an ideal or excessively formal sense unless explicitly defined herein.

The terms used herein are used only to describe specific embodiments and are not intended to limit the present disclosure. The singular expression includes the plural expression unless the context clearly indicates otherwise.

According to an aspect of the present disclosure, a method of manufacturing a carbon nanotube-carbon nanofiber composite is provided, the method including a first step of preparing a spinning solution including an alkali metal precursor and a carbon-containing polymer; a second step of electrospinning the spinning solution to manufacture carbon-containing polymer nanofibers having the alkali metal precursor bound to a surface; a third step of heat-treating the carbon-containing polymer nanofibers to manufacture carbon nanofibers having the alkali metal precursor bound to a surface; and a fourth step of heat-treating the carbon nanofibers while supplying a carbon source to manufacture a carbon nanotube-carbon nanofiber composite having carbon nanotubes bound to a surface.

According to an aspect of the present disclosure, a method of manufacturing a carbon nanotube-carbon nanofiber composite is provided, the method including a first step of preparing a spinning solution including an alkali metal precursor and a carbon-containing polymer; a second step of electrospinning the spinning solution to manufacture carbon-containing polymer nanofibers; a third step of heat-treating the carbon-containing polymer nanofibers to manufacture carbon nanofibers having the alkali metal precursor bound to a surface; and a fourth step of heat-treating the carbon nanofibers while supplying a carbon source to manufacture a carbon nanotube-carbon nanofiber composite having carbon nanotubes bound to a surface, wherein the fourth step includes a carbon nanotube seed formation step of supplying the carbon source to the carbon nanofibers while heating in an inert gas atmosphere so that the alkali metal precursor is activated as an alkali metal nanocatalyst, and forming a carbon nanotube seed for growing into a carbon nanotube as the carbon source is bound to the surface of the carbon nanofibers by the nanocatalyst; a first carbon nanotube growth step of resupplying the carbon source to the carbon nanofibers while heating in an inert gas atmosphere after the carbon nanotube seed formation step to grow carbon nanotubes on the surface of the carbon nanofibers; a nanocatalyst activation step of supplying hydrogen gas after the first carbon nanotube growth step and further activating the nanocatalyst through reduction of the alkali metal nanocatalyst by the hydrogen gas supply; and a second carbon nanotube growth step of resupplying the carbon source in an inert gas atmosphere after the nanocatalyst activation step to further grow carbon nanotubes, thereby manufacturing a carbon nanotube-carbon nanofiber composite having 80 to 120 carbon nanotubes per 1 μm² of the carbon nanofibers on the surface of the carbon nanotube-carbon nanofiber composite.

The present disclosure manufactured nanofibers using an electrospinning method. In addition, during the process of manufacturing carbon nanofibers, an alkali metal catalyst was included inside the fibers, and carbon nanotubes were grown from these catalysts using heat treatment using a carbon source. The nanofibers manufactured in this way were carbonized through a heat treatment process, and carbon nanotubes were grown from the carbon nanofibers using a thermochemical vapor deposition method.

This carbon nanofiber-carbon nanotube composite material has a 3D (three-dimensional) network connection structure based on a 1D (one-dimensional) structure, and thus has a short movement distance for ions and electrons, and thus has excellent ion and electrical conductivity. Therefore, when applied as a secondary battery electrode material, high energy density and improved output characteristics are expected, and when used as a catalyst support for a fuel cell, high output characteristics as well as high durability based on an excellent crystalline internal structure are expected.

In addition, since transition metal catalysts such as Fe, Ni, and Co, which were used in the growth of conventional carbon nanotubes, were not used, it is expected that environmental costs may also be significantly reduced since a cleaning process such as high-concentration acid treatment to remove them is not required.

Furthermore, the steps of manufacturing a carbon nanotube-carbon nanofiber composite in which carbon nanotubes are bonded to the surface were subdivided, and a carbon nanotube-carbon nanofiber composite in which carbon nanotubes are uniformly grown and formed at a high density was manufactured. The specific manufacturing method is described below.

First, a spinning solution including an alkali metal precursor and a carbon-containing polymer is prepared (S1).

Previously, catalysts based on non-alkali metals, i.e., transition metals, of Group 8, 9, and 10, such as Fe, Co, and Ni, were mainly used for the growth of carbon nanotubes on carbon nanofibers, but when the non-alkali metal catalyst is formed in the form of nanoparticles and the synthesis and growth of carbon nanotubes are completed, additional processes such as acid treatment are required to remove the nanoparticles remaining in the metal state of the non-alkali metal catalyst, and since the acid treatment requires washing water, there has been a burden of increased environmental costs.

Accordingly, in the present disclosure, an alkali metal precursor based on a Group 1 element excluding hydrogen is dissolved in a solvent to manufacture an alkali metal precursor solution, so that the alkali metal is activated as a nanocatalyst to grow carbon nanotubes from the surface of carbon nanofibers, and the nanocatalyst may be easily dissolved in water and removed later without having to go through a separate process such as subsequent acid treatment to remove the nanocatalyst, making it possible to synthesize a high-purity carbon nanotube-carbon nanofiber composite.

The alkali metal precursor is selected from the group consisting of a Li precursor, a Na precursor, a K precursor, and mixtures thereof. In other words, the alkali metal precursor may be composed of one or more alkali metal salts, alkali metal organic compounds, or alkali metal inorganic compounds selected from the group consisting of Li, Na, and K.

For example, a Li precursor, which is a lithium-containing compound, is selected from the group consisting of lithium benzoate, lithium chloride (LiCl), and mixtures thereof, a Na precursor, which is a sodium-containing compound, is selected from the group consisting of sodium benzoate, sodium chloride (NaCl), sodium bicarbonate (NaHCO₃), and mixtures thereof, and a Ka precursor, which is a potassium-containing compound, is selected from the group consisting of potassium benzoate, potassium chloride, potassium hydroxide, and mixtures thereof.

The solvent is composed of a polar solvent or a nonpolar solvent, and a polar solvent selected from the group consisting of water, dimethylformamide (DMF), lower alcohols having 1 to 5 carbon atoms, and mixtures thereof, or a nonpolar solvent selected from the group consisting of xylene, benzene, toluene, and mixtures thereof may be selected and used.

An alkali metal precursor solution in which an alkali metal precursor is mixed in a solvent like this is manufactured in the following two ways.

First, an alkali metal precursor solution is manufactured by dissolving an alkali metal precursor in a polar solvent such as dimethylformamide.

It is preferable to dissolve the alkali metal precursor in the range of 0.02 to 0.3 mol per 1 L of solvent, and in this case, the amount of the alkali metal precursor used is not particularly limited, but if it is mixed in an amount less than 0.02 mol per 1 L of solvent, the alkali metal precursor is not activated or functionalized as an alkali metal nanocatalyst when heat treatment is performed, so that it takes a long time until the carbon nanotubes may grow from the surface of the carbon nanofibers, and in some cases, the supplied carbon source may not grow into carbon nanotubes, which limits its application in the field of energy applications, and in particular, if the alkali metal precursor is added in too small amount, the reaction rate cannot be increased, which is not preferable in terms of production efficiency.

Second, an alkali metal precursor solution is manufactured by solvating an alkali metal cation by adding a crown ether so that the alkali metal cation of the alkali metal precursor is coordinated to the cavity of the crown ether to form a complex.

Crown ethers (x-crown ether-y; x represents the total number of atoms in the ring and y represents the number of oxygen atoms) are oligomers of ethylene oxide in which ethyleneoxy (—CH₂CH₂O—) units are repeated, and when an alkali metal cation in an alkali metal precursor solution is inserted into the cavity at the center of the crown ether, a stable structure is formed with the alkali metal cation, allowing the alkali metal cation to be solvated and dissolved, particularly increasing the solubility of the alkali metal precursor as a solute in a nonpolar solvent. In other words, since crown ethers form stable complexes with metal ions, i.e., alkali metal cations such as Li⁺, Na⁺, and K⁺, they may easily solvate alkali metal precursors that are insoluble in nonpolar solvents composed of hydrocarbons such as benzene, xylene, and toluene.

When the alkali metal precursor is dissolved in the solvent through the crown ether, it is converted into a transparent alkali metal precursor solution, and in order to dissolve the maximum amount of alkali metal precursor, it is desirable to control the ratio with the crown ether (for example, the weight ratio of the alkali metal precursor and the crown ether may be 1:0.1 to 100), and the solubility of the alkali metal precursor solution may also be controlled by controlling the amount of the crown ether. However, the amount in which the alkali metal precursor and the crown ether may be mixed is not limited. In the case of the crown ether, it may be selected and used from the group consisting of 12-Crown-4, 15-Crown-5, 18-Crown-6, and mixtures thereof.

In particular, solvents such as water or dimethylformamide presented in the first method are polar, so the alkali metal precursor dissolves well, but the alkali metal precursor does not dissolve in nonpolar solvents (for example, xylene) other than polar solvents, so the crown ether plays an important role in solvating the solute and increasing the solubility.

A spinning solution is manufactured by dissolving a carbon-containing polymer in the alkali metal precursor solution, and it is preferable to manufacture a spinning solution capable of electrospinning by adding 1 to 15 wt % of a carbon-containing polymer to 85 to 99 wt % of the alkali metal precursor solution and dissolving it while stirring.

In particular, if the carbon-containing polymer is less than 1 wt %, it is difficult to form carbon nanofibers having a uniform shape even if the spinning solution is electrospun, and if it exceeds 15 wt %, since the alkali metal precursor solution is contained relatively little, the amount of nanocatalyst to be activated later is relatively reduced, and thus the amount of carbon nanotubes that may be grown from the surface of the carbon nanofibers is also reduced. In other words, if the alkali metal precursor solution is less than 85 wt %, since the amount of nanocatalyst to be activated becomes smaller, there is a disadvantage that the amount of carbon nanotubes that may be grown also becomes smaller, and if the alkali metal precursor solution exceeds 99 wt %, there is a disadvantage that there is not enough space in the carbon nanofibers where the nanocatalyst may be formed, and thus the growth of carbon nanotubes cannot be stably achieved. In order to stably grow carbon nanotubes on carbon nanofibers after complete forming into carbon nanofibers, it is most preferable that the carbon-containing polymer be included at 9 wt %, taking into account solvent volatilization in the alkali metal precursor solution.

The carbon-containing polymer may be referred to as a carbon nanofiber precursor, and may be selected from the group consisting of polyacrylonitrile (PAN), polyvinyl acetate (PVA), polyvinyl pyrrolidone (PVP), polycarbonate (PC), polyvinyl chloride (PVC), cellulose, cellulose acetate, and mixtures thereof, and in the present disclosure, polyacrylonitrile is applied, but any carbon-containing polymer that may be formed into carbon nanofibers is not particularly limited.

Next, the spinning solution is electrospun to manufacture carbon-containing polymer nanofibers (S2).

The spinning solution thus manufactured is electrospun to manufacture carbon-containing polymer nanofibers having an alkali metal precursor bound to the surface. In order to perform electrospinning, first, a (+) or (−) high voltage terminal is connected to the nozzle, and when a sufficiently high voltage is applied while the conductor is grounded, an electromagnetic field is formed between the nozzle and the conductor, and the spinning solution inside the nozzle is affected, and when the electromagnetic force becomes greater than the surface tension and viscosity of the spinning solution, a Taylor cone is formed and stretched at the end to produce a composite nanofiber, which is a nano-sized composite fiber. However, the ‘composite nanofibers’ and ‘nano-sized composite fibers’ mentioned in the present disclosure mean ‘carbon-containing polymer nanofibers having an alkali metal precursor bound to the surface.’

In order to fabricate nano-sized composite fibers through electrospinning, it is preferable to satisfy the conditions of molecular weight of the carbon-containing polymer, properties of the spinning solution, voltage, distance between the nozzle and the conductor, fluid amount and concentration of the carbon-containing polymer, parameters, movement of the nozzle, size of the conductor, and size of the nozzle.

The conditions for the molecular weight of the carbon-containing polymer are as follows. In other words, if the molecular weight (Mw) of the carbon-containing polymer is less than 45,000 or exceeds 1,000,000, it is difficult to uniformly form composite nanofibers, and therefore it is preferable to make it within the range of 45,000 to 1,000,000.

With respect to the viscosity of the spinning solution, if the viscosity is less than 1 Pa·s, the viscosity is too low and the spinning solution breaks before being formed into nano-sized composite fibers during the electrospinning process, resulting in a droplet shape rather than a composite nanofiber shape, and if the viscosity exceeds 1,000 Pa·s, the viscosity becomes too high and more electromagnetic force is required to elute from the nozzle, which may cause an overcurrent and burn out the experimental equipment, and therefore, it is preferable to have a viscosity in the range of 1 to 1,000 Pa·s. With respect to the conductivity of the spinning solution, if the conductivity exceeds 53 μs/cm, it is not suitable for forming carbon nanofibers, and therefore, it is preferable for the spinning solution to have a conductivity of 53 μs/cm or less. With respect to the surface tension of the spinning solution, if the surface tension exceeds 450 dyn/cm, the electromagnetic force becomes smaller than the surface tension of the spinning solution, resulting in the disadvantage that the Taylor cone formation is not achieved and it is difficult to form a composite nanofiber shape, and therefore, it is preferable that the surface tension of the spinning solution is 450 dyn/cm or less.

In the case of voltage conditions, if a voltage of 30 kV or less is applied for electrospinning of the spinning solution, an electromagnetic field is formed between the nozzle and the conductor, so there is no need to apply a voltage exceeding 30 kV.

The distance between the nozzle and the conductor, i.e., the distance between the nozzle containing the spinning solution and the conductor, is 30 cm or less to form nano-sized composite fibers. If the distance between the nozzle and the conductor exceeds 30 cm, the distance between the nozzle and the conductor is too far, so that the electromagnetic force becomes smaller, making it difficult to uniformly form the nano-size of the composite fibers, and there is a disadvantage that a droplet shape rather than a nanofiber may be seen. It may be preferably less than 10 cm.

In the case of the fluid amount of the carbon-containing polymer, it should be 25 ml/min or less so that the spinning solution is formed into a Taylor cone and stretched well into nanofibers, but if it exceeds 25 ml/min, the fluid amount is too large and the stretching amount is small, so that the probability of manufacturing uneven nanofibers increases, which may also increase the defect rate.

In the case of the carbon-containing polymer concentration, it is preferable to be 7 to 11 wt % to be manufactured into nano-sized fibers.

The parameters are related to basic environmental aspects such as temperature, humidity, and airflow, and in an environment where the temperature is 35° C. or less, the humidity is 60% or less, and the airflow is 1 or less, it is possible to manufacture carbon-containing polymer nanofibers with an alkali metal precursor bound to the surface through electrospinning.

The nozzle movement and conductor size conditions are as follows. First, the electrospinning solution may be stably stretched into a conductor only when the movement of the nozzle is less than 0.1 mm/min, and even if the size of the conductor is 10 cm² or larger, the composite nanofibers electrospun from the nozzle may be stably captured on the conductor. However, if the conductor size is less than 10 cm², there is a disadvantage in that the area is too small to secure a space sufficient to capture the composite nanofibers.

The nozzle size conditions are as follows. When the nozzle size is less than 0.01 mm or more than 1.7 mm, it does not help in the formation of carbon nanofibers having an alkali metal precursor bound to the surface, so the nozzle size is preferably in the range of 0.01 to 1.7 mm.

Before manufacturing carbon nanofibers through carbonization, carbon-containing polymer nanofibers having an alkali metal precursor bound to the surface are subjected to preliminary heat treatment in the atmosphere at a heating rate of 8 to 12° C./min to 100 to 300° C. for 20 minutes to 1 hour to stabilize the carbon-containing polymer. At this time, if the preliminary heat treatment is performed below 100° C., it is difficult to stabilize the carbon-containing polymer nanofibers, and if the preliminary heat treatment is performed above 300° C., the temperature is unnecessarily high, which may cause deterioration of the shape or physical properties of the nanofibers.

The heating rate may be 8 to 12° C./min, and 10° C./min is most preferable. In addition, if the preliminary heat treatment is performed for less than 20 minutes, it is difficult to stabilize the carbon-containing polymer of the carbon-containing polymer nanofibers, similar to the temperature conditions, and if the preliminary heat treatment is performed for more than 1 hour, there is no excellent effect compared to the case where it is performed for the same or less time. In particular, preliminary heat treatment should be performed in an oxygen environment in the atmosphere, which has the advantage of allowing rapid formation of carbon-containing polymer nanofibers due to smooth oxygen supply.

The diameter of the carbon nanofibers of the present disclosure manufactured accordingly may be 150 to 200 nm, but is not limited thereto.

Next, the carbon-containing polymer nanofibers are heat-treated to manufacture carbon nanofibers having the alkali metal precursor bound to the surface (S3).

After the formation of nanofibers that stabilize the carbon-containing polymer, carbonization is performed through additional heat treatment at a heating rate of 3 to 7° C./min to 800 to 1,200° C. for 30 minutes to 1 hour and 30 minutes in an inert gas atmosphere, followed by a natural cooling process, thereby completing the manufacture of carbon nanofibers. Here, carbonization refers to a heat treatment process that increases the carbon/hydrogen ratio of the carbon-containing polymer forming the carbon-containing polymer nanofibers, and refers to a process of converting the carbon-containing component into carbon.

Regarding the heating rate for carbonization, the reason why the heating rate is relatively slow, at 3 to 7° C./min, compared to the preliminary heat treatment to stabilize the carbon-containing polymer nanofibers is to check whether there is a problem in forming carbon nanofibers while the temperature increases during the carbonization process, and to prevent deterioration of the physical properties of the carbon nanofibers. It is most preferable to perform the process at 5° C./min for stable carbon nanofiber manufacturing.

Regarding the heat treatment time for carbonization, if it is less than 30 minutes, the intended carbonization effect is insignificant, and if it exceeds 1 hour and 30 minutes, it is too long, which highlights the inefficient aspect in terms of process efficiency. From the perspective of process efficiency, it is most preferable to carbonize by heat treatment for 60 minutes.

In the present disclosure, the inert gas atmosphere may use, for example, a gas such as helium, nitrogen, argon, or carbon dioxide. In other words, the carbon-containing polymer of the carbon-containing polymer nanofibers may be carbonized by heat treatment under an inert atmosphere and converted into carbon nanofibers.

Finally, a carbon nanotube-carbon nanofiber composite having carbon nanotubes bound to the surface is manufactured by heat-treating the carbon nanofibers while supplying a carbon source (S4).

First, conventionally, the main method for growing carbon nanotubes on carbon nanofibers was to coat carbon nanofibers with a non-alkali metal catalyst such as Fe, and then pass carbon dioxide and other carbon-containing gases through them, causing carbon atoms to dissolve in the Fe particles, ultimately forming vertical tubes of carbon atoms around the carbon nanofibers. However, in this case, the Fe particles remained inside the carbon nanotubes, so there was a disadvantage in that acid treatment had to be repeated several times to remove the Fe particles.

To improve this, a method was developed in which the alkali metal of the alkali metal precursor was activated as a nanocatalyst, and the carbon source was crystallized into carbon nanotubes through this nanocatalyst and grown from the surface of the carbon nanofibers, but since the thickness (diameter) of the carbon nanofibers was uneven, there was a problem in that the density and length of the growing carbon nanotubes showed a large deviation and a structurally non-uniform shape appeared. In other words, there was difficulty in controlling the length and detailed density of carbon nanotubes.

Accordingly, the present disclosure is characterized in that the steps of manufacturing the carbon nanotube-carbon nanofiber composite are specified and the conditions are controlled to manufacture a carbon nanotube-carbon nanofiber composite in which the length and density of the carbon nanotubes are controlled and a uniform structure is formed.

Specifically, the step (S4) of manufacturing the carbon nanotube-carbon nanofiber composite includes a carbon nanotube seed formation step (S4-1) of supplying the carbon source to the carbon nanofibers while heating in an inert gas atmosphere so that the alkali metal precursor is activated as an alkali metal nanocatalyst, and forming a carbon nanotube seed for growing into a carbon nanotube as the carbon source is bound to the surface of the carbon nanofibers by the nanocatalyst; a first carbon nanotube growth step (S4-2) of resupplying the carbon source to the carbon nanofibers while heating in an inert gas atmosphere after the carbon nanotube seed formation step to grow carbon nanotubes on the surface of the carbon nanofibers; a nanocatalyst activation step (S4-3) of supplying hydrogen gas after the first carbon nanotube growth step and further activating the nanocatalyst through reduction of the alkali metal nanocatalyst by the hydrogen gas supply; and a second carbon nanotube growth step (S4-3) of resupplying the carbon source in an inert gas atmosphere after the nanocatalyst activation step to further grow carbon nanotubes.

First, carbon nanotube seeds are formed (S4-1).

In the case of the nanocatalyst of the present disclosure, an alkali metal precursor may be activated into an alkali metal nanocatalyst simply by heat treatment in the presence of a carbon source without the need to separately prepare a Group 1 element other than hydrogen, particularly sodium, as a catalyst in the form of particles. The nanocatalyst may form a carbon nanotube seed that allows only pure carbon nanotubes to grow from the surface of carbon nanofibers.

As an embodiment, a carbon source vapor may be supplied into the inside of a quartz tube through argon gas bubbling to activate the seed on the surface of the carbon nanotube fiber.

Although the nanocatalyst is an alkali metal, the alkali metal of the alkali metal precursor applied in the present disclosure, especially sodium, is soluble in water, so there is no need to use a separate acid to remove it, and thus a metal-free carbon nanotube-carbon nanofiber composite may be synthesized. In other words, there is an effect that, even if some of the nanocatalyst remains in the carbon nanotube, it may be removed by dissolving in normal water rather than acid treatment due to the high reactivity of the alkali metal cation. In addition, it may be removed simply by vaporization or evaporation by the heat treatment temperature.

After forming carbon nanotube seeds on the surface of the carbon nanofibers, the heated carbon source is resupplied in an inert gas atmosphere to primarily grow carbon nanotubes on the surface of the carbon nanotube fibers (S4-2).

Since the carbon nanotubes are grown from the carbon nanofibers through the nanocatalyst, the high bonding force between the carbon nanofibers and the carbon nanotubes is generated, and the carbon nanofibers and the carbon nanotubes are not separated, a separate means for bonding the carbon nanofibers and the carbon nanotubes to each other is not required. The carbon source may be grown from the surface of the carbon nanofibers while being crystallized into carbon nanotubes by the nanocatalyst.

Specifically, in order to grow carbon nanotubes on the carbon nanofibers, a quartz tube may be positioned centrally inside an electric heater, and the temperature inside the quartz tube may be maintained at 600 to 700° C., and the temperature may be increased at 10° C. per minute in a hydrogen atmosphere to prepare.

As a carbon source capable of growing and synthesizing carbon nanotubes from the surface of the carbon nanofibers, any one or more of a liquid-type liquid-phase carbon source, a gas-type gas-phase carbon source, and a solid-type solid-phase carbon source is selected and used. The liquid-phase carbon source is selected from the group consisting of ethanol (C₂H₆O), benzene (C₆H₆), xylene, toluene (C₇H₈), and mixtures thereof. The gas-phase carbon source is selected from the group consisting of methane (CH₄), propylene (C₃H₆), propyne (C₃H₄), propane (C₃H₈), butane (C₄H₁₀), butylene (C₄H₈), butadiene (C₄H₆), ethylene (C₂H₂), and mixtures thereof. As the solid-phase carbon source, camphor (C₁₀H₁₆₀), which is one of the monoterpene ketones, may be used.

As the inert gas, gases such as helium, nitrogen, argon, carbon dioxide, etc., may be used.

Preferably, the carbon source may be supplied by vaporizing a liquid-phase carbon source, and as an example, ethanol may be heated to 150° C., and ethanol vapor generated may be supplied into the quartz tube through argon gas bubbling at 1000 to 2400 sccm.

Next, hydrogen gas is supplied, and the nanocatalyst is further activated through reduction of the alkali metal nanocatalyst according to the supply of the hydrogen gas (S4-3).

The present disclosure has a technical feature in that it further includes a nanocatalyst activation step according to the supply of hydrogen gas in the middle of the carbon nanotube growth step, thereby uniformly growing carbon nanotubes and increasing the density of carbon nanotubes on the surface of carbon nanofibers.

The hydrogen gas supplied in the middle may assist the further reduction of the alkali metal nanocatalyst, further promoting the activation degree of the catalyst, and increasing the purity of the carbon nanotubes. Through this, the activation degree of the limited alkali metal nanocatalyst may be increased, and the concentration of the alkali metal precursor may be increased from 0.02 mol to 0.3 mol per 1 L of solvent and used in the process.

In an embodiment, hydrogen gas may be supplied at 200 to 500 sccm for at least 30 minutes.

Thereafter, the carbon source is resupplied in an inert gas atmosphere to further grow carbon nanotubes (S4-4).

S4-4 may be performed under the same conditions as S4-2, and carbon nanotubes may be grown from the further activated nanocatalyst in S4-3. Accordingly, the carbon nanotube-carbon nanofiber composite of the present disclosure is characterized in that 80 to 120 carbon nanotubes are formed per 1 μm² of the carbon nanofibers on the surface.

Conventionally, even when carbon nanofibers and carbon nanotubes were composited, the density of carbon nanotubes was low. In this case, only 10 to 30 carbon nanotubes were formed per 1 μm² of the carbon nanofibers. On the other hand, when carbon nanotubes are grown under controlled conditions according to the present disclosure, there is an excellent technical characteristic in that the density is increased by about 3 to 10 times compared to the prior art, with 80 to 120 carbon nanotubes per 1 μm² of the carbon nanofibers.

In addition, the length of the carbon nanotubes in the carbon nanotube-carbon nanofiber composite is 30 to 120 nm, and preferably 50 to 100 nm. In the case of the prior art, the diameter of the carbon nanofibers was 250 to 2000 nm, the diameter of the carbon nanotubes was 50 to 70 nm, and the length of the carbon nanotubes was 200 to 500 nm, so there were problems that the thickness (diameter) of the carbon nanofibers was uneven and there was a large deviation in the length of the growing carbon nanotubes, but when carbon nanotubes are grown under controlled conditions according to the present disclosure, there is a characteristic in that the length is formed uniformly.

When the density and length are out of the above range, not only will the electrical conductivity decrease due to the lack of an electrical conduction path, but the composite may also be limited in various applications due to insufficient growth of carbon nanotubes. For example, when evaluating performance as a lithium-ion battery anode, when the range is out of the above range, there was no significant difference in performance from a single carbon nanofiber.

The present disclosure can manufacture a metal-free carbon nanotube-carbon nanofiber composite using an alkali metal-based nanocatalyst, and since the nanocatalyst may be vaporized and removed, there is no need to perform a post-treatment process such as an additional heat treatment or acid treatment to remove the nanocatalyst because the nanocatalyst is not attached or bound to the carbon nanotubes grown on the carbon nanofibers. In addition, even if a portion of the nanocatalyst remains in the carbon nanotube, it may be removed by dissolving in normal water rather than acid treatment due to the high reactivity of alkali metal ions to water, so that the process advantage is maintained.

Furthermore, the present disclosure is characterized in that it specifies the steps of manufacturing a carbon nanotube-carbon nanofiber composite and controls the conditions to manufacture a carbon nanotube-carbon nanofiber composite in which the length and density of the carbon nanotubes are controlled and a uniform structure is formed.

Further, according to an aspect of the present disclosure, a method of manufacturing a branched fine carbon nanofiber-carbon nanofiber composite is provided, the method including a first step of preparing a spinning solution including an alkali metal precursor and a carbon-containing polymer; a second step of electrospinning the spinning solution to manufacture carbon-containing polymer nanofibers having the alkali metal precursor bound to a surface; a third step of heat-treating the carbon-containing polymer nanofibers to manufacture carbon nanofibers having the alkali metal precursor bound to a surface; and a fourth step of heat-treating the carbon nanofibers while supplying a carbon source to manufacture a branched fine carbon nanofiber-carbon nanofiber composite having branched fine carbon nanofibers bound to a surface.

The present disclosure may provide a method of manufacturing a branched fine carbon nanofiber-carbon nanofiber composite, in addition to the carbon nanotube-carbon nanofiber composite. The branched fine carbon nanofiber-carbon nanofiber composite is a structure in which branched fine carbon nanofibers, rather than carbon nanotubes, grow from the surface of the carbon nanofibers. The branched structure refers to a structure in which fine fibers grow in multiple directions when a carbon source is supplied to the surface of the carbon nanofibers formed through an electrospinning and carbonization process and heat treatment is performed.

A structure formed in this manner may exhibit properties ideal for energy storage and conversion devices, providing higher reactivity, larger surface area, improved electrical conductivity, and ion diffusion characteristics. For example, when applied as an anode material for a lithium-ion battery, it may simultaneously realize high energy density and excellent rate characteristics, and may be utilized as a composite material for high-performance electrodes such as supercapacitors and fuel cell electrode materials.

Further, according to an aspect of the present disclosure, a method of manufacturing a branched fine carbon nanofiber-carbon nanofiber composite is provided, the method including a first step of preparing a spinning solution comprising an alkali metal precursor and a carbon-containing polymer; a second step of electrospinning the spinning solution to manufacture carbon-containing polymer nanofibers having the alkali metal precursor bound to a surface; a third step of heat-treating the carbon-containing polymer nanofibers to manufacture carbon nanofibers having the alkali metal precursor bound to a surface; and a fourth step of heat-treating the carbon nanofibers while supplying a carbon source to manufacture a branched fine carbon nanofiber-carbon nanofiber composite having branched fine carbon nanofibers bound to a surface, wherein the fourth step includes a branched fine carbon nanofiber seed formation step of supplying the carbon source to the carbon nanofibers while heating in an inert gas atmosphere so that the alkali metal precursor is activated as an alkali metal nanocatalyst, and forming a branched fine carbon nanofiber seed for growing into branched fine carbon nanofibers as the carbon source is bound to the surface of the carbon nanofibers by the nanocatalyst; a first branched fine carbon nanofiber growth step of resupplying the carbon source to the carbon nanofibers while heating in an inert gas atmosphere after the branched fine carbon nanofiber seed formation step to grow branched fine carbon nanofibers on the surface of the carbon nanofibers; a nanocatalyst activation step of supplying hydrogen gas after the first branched fine carbon nanofiber growth step and further activating the nanocatalyst through reduction of the alkali metal nanocatalyst by the hydrogen gas supply; and a second branched fine carbon nanofiber growth step of resupplying the carbon source in an inert gas atmosphere after the nanocatalyst activation step to further grow branched fine carbon nanofibers, thereby manufacturing a branched fine carbon nanofiber-carbon nanofiber composite having 80 to 120 branched fine carbon nanofibers per 1 μm² of the carbon nanofibers on the surface of the branched fine carbon nanofiber-carbon nanofiber composite.

According to an embodiment of the present disclosure, a carbon-containing polymer nanofiber including an alkali metal precursor is converted into a carbon nanofiber through electrospinning and heat treatment, and branched fine carbon nanofibers are grown from the surface of the carbon nanofiber, thereby manufacturing a branched fine carbon nanofiber-carbon nanofiber composite.

The manufacturing method includes four steps.

In a first step, a spinning solution including an alkali metal precursor such as lithium, sodium, and potassium and a carbon-containing polymer is prepared. Here, a polar solvent such as water, dimethylformamide (DMF), and lower alcohols having 1 to 5 carbon atoms, or a nonpolar solvents such as xylene, benzene, and toluene may be used as a solvent, and if necessary, a crown ether may be added to improve the solubility of the alkali metal precursor.

In a second step, the spinning solution is electrospun to form carbon-containing polymer nanofibers including the alkali metal precursor. During electrospinning, viscosity, conductivity, surface tension, voltage, and spinning conditions should be appropriately controlled, and the viscosity of the spinning solution may be set to 1 to 1,000 Pa's, the conductivity to 53 μs/cm or less, and the surface tension to 450 dyn/cm or less.

In a third step, the electrospun nanofibers are first stabilized, and then carbonization heat treatment is performed in an inert gas atmosphere to manufacture carbon nanofibers having the alkali metal precursor bound to a surface. The heat treatment temperature is preferably 800 to 1,200° C., and the time is preferably 30 to 90 minutes.

In a fourth step, a carbon source is supplied to the carbon nanofibers and heat treatment is performed to induce formation of branched fine carbon nanofibers on the surface. In particular, this step is subdivided into the following sub-steps:

### 1) Branched Fine Carbon Nanofiber Seed Formation Step

By heating and supplying the carbon source in an inert gas atmosphere, the alkali metal precursor present on the surface of the carbon nanofibers is activated as an alkali metal nanocatalyst, and the carbon source is adsorbed and bound based on the nanocatalyst to form a growth nucleus (seed) of branched fine carbon nanofibers.

### 2) First Branched Fine Carbon Nanofiber Growth Step

After seed formation, the carbon source is heated and resupplied in an inert gas atmosphere, and a fibrous carbon structure with a branched structure, i.e., branched fine carbon nanofibers, grow on the surface of the carbon nanofibers.

### 3) Nanocatalyst Activation Step

By supplying hydrogen gas, reduction and reactivation of the alkali metal nanocatalyst are induced. This improves the catalytic activity and enables growth of more uniform and high-density branched fine carbon nanofibers in the subsequent step.

### 4) Second Branched Fine Carbon Nanofiber Growth Step

The carbon source is supplied again to further grow branched fine carbon nanofibers. This completes a composite structure with high density and bonding strength.

The composite manufactured through the above four-step process has a structure in which 80 to 120 branched fine carbon nanofibers are formed per 1 μm² of carbon nanofibers, and provides excellent performance in terms of electrical conductivity, surface area, and mechanical stability.

In particular, the present disclosure does not use transition metal-based catalysts such as iron (Fe) and nickel (Ni), which are commonly used in existing technologies, but uses an alkali metal-based nanocatalyst that is easily soluble in water, so a post-treatment process such as acid treatment is unnecessary, and environmental pollution and production costs may be significantly reduced.

This branched fine carbon nanofiber-carbon nanofiber composite may be utilized as electrode materials for high-performance energy storage and conversion devices such as lithium-ion batteries, fuel cells, and supercapacitors, and may be effectively applied to various applications such as functional filters, electronic devices, and composite material reinforcement due to their porous structure and high reactivity.

Hereinafter, the embodiments of the present disclosure will be described in more detail as follows. However, the following embodiments are merely illustrative to help understand the present disclosure, and the scope of the present disclosure is not limited thereby.

### EXAMPLE

The present example fabricated nanofibers through electrospinning and used chemical vapor deposition to synthesize carbon nanotubes on the fabricated carbon nanofibers, and various experiments were performed to determine variables such as the amount of catalyst, concentration of the spinning solution, carbon source, gas injection distance, heat treatment time, and gas flow rate.

### Manufacture of Carbon Nanofibers Using Electrospinning

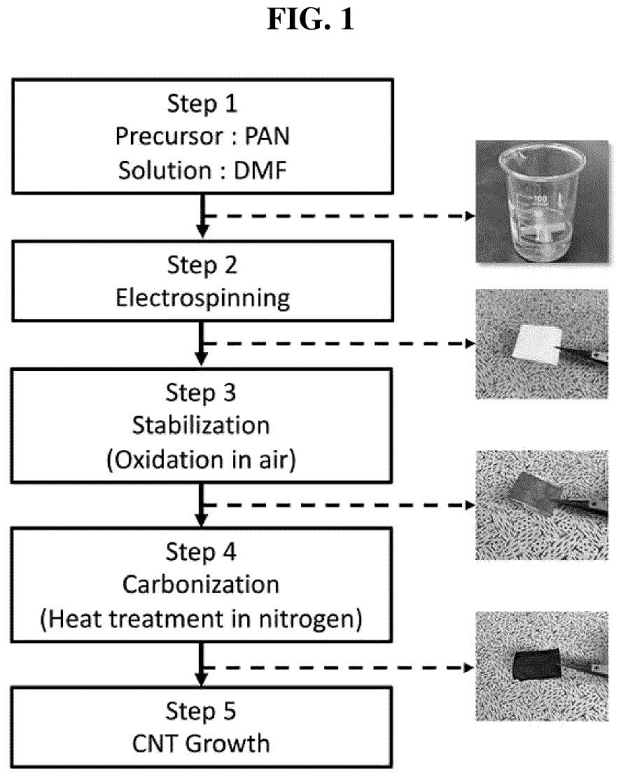

In order to manufacture carbon nanofibers, polyacrylonitrile (PAN, Sigma-Aldrich) was used as a carbon precursor, and a product having a molecular weight of 150,000 g/mol was used to maintain an appropriate viscosity. FIG. 1 illustrates a step of manufacturing carbon nanofibers according to an embodiment of the present disclosure.

In addition, an alkali metal was used as a catalyst for growing carbon nanotubes from carbon nanofibers. Generally, carbon nanotubes are synthesized using a transition metal catalyst, but such a transition metal catalyst has a disadvantage in that it must be removed through acid washing, or the like, because it acts as an impurity later and causes various side reactions, causing many problems. On the other hand, an alkali metal is easily dissolved in water, so unlike a transition metal, a purification process through acid treatment is not necessary, and it has the advantage of being sufficiently removed through a low-temperature heat treatment, so an alkali metal was used as a catalyst. The catalyst used was lithium benzoate (C₇H₅LiO₂, Sigma-Aldrich), which was added to an N,N-Dimethylformamide (DMF, Sigma-Aldrich) solvent at a molar concentration of 0.3 mol/L and stirred in a stirrer for more than 1 hour. Thereafter, 9 wt % high molecular PAN powder was added and stirred again in a stirrer to complete the spinning solution.

Furthermore, in order to fabricate carbon nanofibers with an even surface and no beads, the concentration of the spinning solution was varied and confirmed. PAN was dissolved in DMF, a carbon-containing polymer solvent, at 7 wt %, 9 wt %, and 11 wt %, respectively, and electrospun. In addition, lithium benzoate, a lithium precursor, was dissolved at 0.03 mol/L and 0.3 mol/L to confirm the amount for growing carbon nanotubes with a high yield.

The manufactured spinning solution was fabricated into nanofibers through an electrospinning system (Nano NC). The distance between the nozzle and the collecting plate was 20 cm, and 12 kV voltage was applied therebetween to obtain nanofibers.

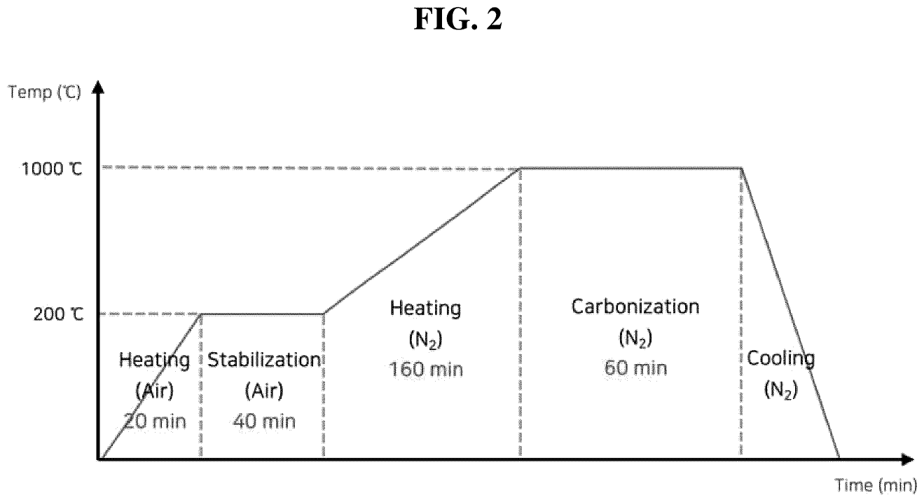

The stabilization and carbonization process of the nanofibers after spinning were carried out in a quartz tube with a diameter of 50 mm and a length of 1000 mm, and were carried out using an infrared heat treatment furnace. FIG. 2 is a graph illustrating conditions of a carbon nanofiber stabilization and carbonization step according to an embodiment of the present disclosure. Referring to FIG. 2, the stabilization process of the nanofibers was carried out first in an air atmosphere at 200° C. for 40 minutes, and then the nanofibers were carbonized by heating at 1,000° C. for 1 hour at a heating rate of 5° C./min in a nitrogen atmosphere. Thereafter, the nanofibers were cooled to room temperature in a nitrogen atmosphere.

### Manufacture of Carbon Nanofiber-Carbon Nanotube Composites

Chemical vapor deposition was used to grow carbon nanotubes in carbon nanofibers. An alumina boat was placed in the center of the quartz tube used for the carbonization process, and the carbonized carbon nanofibers were placed on top of it. Ethanol (C₂H₆O, Duksan) was used as the carbon precursor required for the growth of carbon nanotubes. Various liquid-phase carbon sources were used to find the carbon source with the best yield and quality of carbon nanotubes. During the process, a process of finding the optimal experimental conditions was carried out by adjusting the distance between the gas injection part and the carbon nanofibers located in the quartz tube.

In order to grow carbon nanotubes on carbon nanofibers, a quartz tube was placed centrally inside an electric heater, and the temperature inside the quartz tube was maintained at 650° C. and increased at 10° C. per minute (hydrogen atmosphere). Thereafter, ethanol was heated to 150° C., and the generated ethanol vapor was supplied into the quartz tube through argon gas bubbling at 2,400 sccm for 30 minutes to form seeds on the surface of the carbon nanofibers.

After removing the heating tape, ethanol vapor was supplied at 2400 sccm for 30 minutes through argon gas bubbling. Thereafter, the hydrogen gas line was changed, hydrogen gas was supplied at 300 sccm for 30 minutes, and then ethanol vapor was supplied again at 2,400 sccm for 30 minutes through argon gas bubbling.

Specifically, ethanol vapor at 650° C. was supplied into the quartz tube through argon gas bubbling at 2,400 sccm. During the first 30 minutes, the quartz tube through which ethanol vapor flowed was heated to 400° C. using a heating tape, thereby increasing the activation degree of ethanol while reaching the carbon nanofibers inside the quartz tube.

After ethanol vapor was supplied for about 30 minutes, hydrogen gas was injected at 300 sccm for 30 minutes. The high energy by the heated ethanol and the hydrogen gas supplied in the middle assisted the further reduction of the alkali metal nanocatalyst, further promoting the activation degree of the catalyst and rather increasing the purity of the carbon nanotubes. Through this, the activation degree of the limited alkali metal nanocatalyst could be increased, and the concentration of the alkali metal precursor could be increased from 0.02 mol to 0.3 mol per 1 L of solvent.

At this time, the exact amount of gas was supplied by controlling it with a mass flow controller (MFC). Argon gas was injected into the Erlenmeyer flask through the MFC, and ethanol heated to 150° C. was bubbled inside the Erlenmeyer flask and supplied into the quartz tube, and at this time, the amount and length of carbon nanotubes were to be controlled by the amount and time of the supplied argon gas. After the heat treatment was completed, only argon gas was injected to prevent the carbon nanotubes from burning and cooled them to room temperature.

Furthermore, the growth degree of carbon nanotubes according to the reaction time was confirmed while conducting experiments with heat treatment times of 15, 30, and 60 minutes to grow carbon nanotubes. The gas injected here was argon gas, and the carbon source was bubbled and then injected into the quartz tube. At this time, the same experiment was conducted at 400 sccm, 1,000 sccm, and 2,400 sccm of argon gas flow rate, and the growth trend of each carbon nanotube was confirmed.

### Manufacture of Lithium Ion Battery

The fabricated carbon nanotube-carbon nanofiber composite was punched into a circle with a diameter of 14 mm to prepare for cell assembly. Unlike general lithium-ion batteries, a binder, a current collector, and an active material were not used, and the fabricated sample weighed approximately 2 mg. The lithium-ion battery was assembled as a coin cell of the CR2030 type (Wellcose Corp.).

The cell consists of a case, a spacer disk, a spring, a gasket, and a cap, and lithium metal was used as the counter electrode. All assembly processes were performed in a glove box filled with argon gas.

Polypropylene (Celgard 2400) was used as a separator, and a solvent containing 1M lithium hexafluorophosphate (LiPF₆) dissolved in ethylene carbonate and dimethyl carbonate in a volume ratio of 1:1 was used as an electrolyte.

### <Experimental Example>: Analysis of Carbon Nanofiber-Carbon Nanotube Structure

(1) The shape and microstructure of the synthesized carbon nanofiber-carbon nanotube were analyzed using a field emission transmission electron microscope (FE-TEM, JEOL, JEM-2100F). FE-TEM irradiates an electron beam onto a sample, and the electron beam collides with the atoms that make up the inside of the sample, and the electrons that pass through the sample are used to obtain an image of the sample. The sample was prepared by adding a small amount of ethanol, dispersing it with ultrasonic waves, placing it on a carbon grid, and drying it, and the analysis was performed by setting the acceleration voltage to 200 kV.
(2) The presence and distribution of lithium ions on the surface of the carbon nanofiber-carbon nanotube were confirmed using a time of flight secondary ion mass spectrometer (ToF-SIMS), and the ToF-SIMS 5 model from ION-ToF GmbH was used. The mass spectrum was analyzed by measuring the time it takes for the ions to fly from the ion source to the detector when the secondary ions of the ionized sample surface were accelerated at a constant acceleration voltage using a pulsed primary ion beam to ionize the material on the sample surface.
(3) The chemical composition of the sample was identified using X-ray photoelectron spectroscopy (XPS). When the sample is exposed to X-rays with a constant energy, photoelectrons are emitted from the sample. At this time, the binding energy may be determined by measuring the kinetic energy of these photoelectrons. The chemical bonding state and qualitative analysis of the elements were determined from the measurement of this binding energy, which is a unique property of atoms. ESCALAB 250 from Thermofisher was used.
(4) Nitrogen adsorption/desorption isotherms were measured using BELSORP-max equipment from MicrotracBEL. The specific surface area of the sample is measured by the volumetric adsorption method. It is also possible to measure the pore size and the chemical adsorption of the compound is measured. It is possible to measure the pore size of micropores (2 nm or less), mesopores (2 to 50 nm), and macropores. The specific surface area was calculated using the Brunauer-Emmett-Teller (BET) method. The pore size was calculated using the Barrett-Joyner-Halena (BJH) method and the micropore analysis (MP) method.
(5) The degree of graphite crystallization according to the carbon nanotube growth density of pure carbon nanofibers and carbon nanofiber-carbon nanotubes was confirmed using a micro Raman spectrometer, and the NRS-5100 equipment from JASCO was used. By detecting the wavelength change and intensity of light scattered by a laser with a CCD detector, the vibrational energy structure of molecules was obtained as a spectrum, and the bonding state, structure, and properties between molecules were confirmed.
(6) A four point probe was used to measure the electrical conductivity and resistance of pure carbon nanofibers and carbon nanofiber-carbon nanotubes, and the 4PX-P200 equipment from WIT was used. The resistance characteristics were analyzed accurately and quickly without destroying the sample by measuring the voltage by supplying a constant current.

### <Evaluation and Results>

### (1) Electrospinning and Chemical Vapor Deposition Condition Setting

### Carbon-Containing Polymer Concentration

In order to find conditions under which beads are not formed in the fibers when fabricating nanofibers through electrospinning, the carbon-containing polymer polyacrylonitrile was used in the solvent DMF at concentrations of 7 wt %, 9 wt %, and 11 wt %, respectively, and compared.

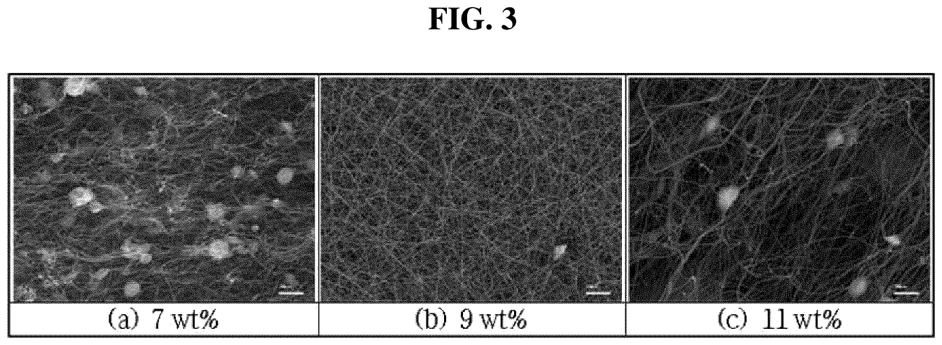

FIG. 3 is an SEM image of carbon nanofibers, for each carbon-containing polymer concentration, manufactured according to an embodiment of the present disclosure. Referring to FIG. 3, at a concentration of 7 wt %, the viscosity of the spinning solution was low, so the voltage had to be increased during electrospinning, and beads were formed accordingly. On the other hand, at a concentration of 11 wt %, the viscosity was high, so spinning did not occur well, and beads were formed. However, at a concentration of 9 wt %, spinning was performed well at a voltage of 11 kV with an appropriate viscosity, and nanofibers without beads were formed.

### Catalyst Precursor Concentration

In order to examine the effect of the concentration of the catalyst precursor on the growth of carbon nanotubes, the amount of lithium benzoate, a catalyst precursor contained in the spinning solution, was varied and compared. Carbon nanofibers were fabricated by adding lithium benzoate to the spinning solution solvent, DMF, at 0.03 mol/L and 0.3 mol/L.

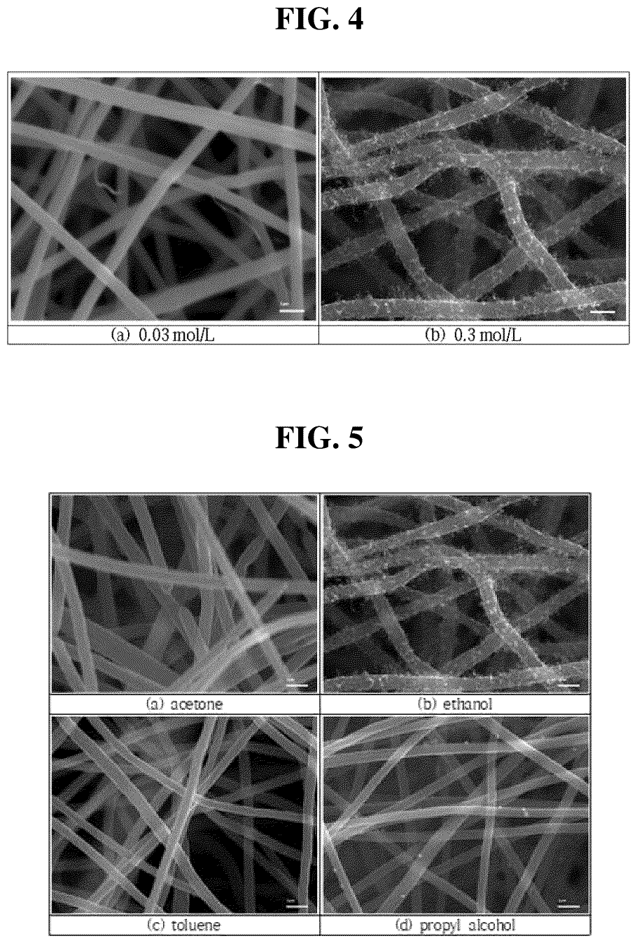

FIG. 4 is an SEM image of a carbon nanofiber-carbon nanotube composite, for each catalyst precursor concentration, manufactured according to an embodiment of the present disclosure. Referring to FIG. 4, the density of carbon nanotubes according to the catalyst concentration is shown. At 0.03 mol/L, carbon nanotubes were sparsely grown on the carbon nanofibers, while at 0.3 mol/L, carbon nanotubes were grown at a high density. This shows that the density of carbon nanotubes increases as the amount of catalyst increases.

### Carbon Source Selection

In order to select a carbon source suitable for carbon nanotube growth, experiments were conducted using various carbon sources. FIG. 5 is an SEM image of a carbon nanofiber-carbon nanotube composite, for each carbon source, manufactured according to an embodiment of the present disclosure. A liquid carbon source was used as the carbon source, and referring to FIG. 5, first, in an experiment using acetone (C₃H₆O, Duksan), it was confirmed that carbon nanotubes hardly grew from the carbon nanofibers. Next, in an experiment using ethanol (C₂H₆O, Duksan), it was confirmed that high-density carbon nanotubes grew. This is believed to be because the OH radicals contained in ethanol and propanol activated the surface of the carbon fiber, allowing the carbon source to easily diffuse and dissolve to the catalyst present on the surface of the carbon fiber, thereby helping to grow the tubes.

To confirm this, additional experiments were conducted using toluene (C₇H₈, Sigma-Aldrich) and propanol (propyl alcohol, C₃H₈O Duksan), and it was confirmed that small carbon nanotubes of 10 nm were grown only in propanol. This confirmed that OH radicals affect the growth of carbon nanotubes. As a result, it was confirmed that even if the carbon source contains the same OH functional group, the higher the ratio of hydrocarbons excluding OH groups, the lower the frequency of occurrence of OH groups, which may affect the growth of carbon nanotubes.

### Distance Between Gas Inlet and Carbon Nanofibers

In the chemical vapor deposition method, the difference in the growth density of carbon nanotubes was observed by controlling the distance between the gas inlet and the carbon nanofibers located inside the quartz tube. First, heat treatment was performed by bringing the carbon nanofibers and the gas inlet as close as possible to a distance of 10 cm, and then the carbon nanofibers were placed in the middle of the quartz tube and the experiment was performed at a distance of about 30 cm from the gas inlet.

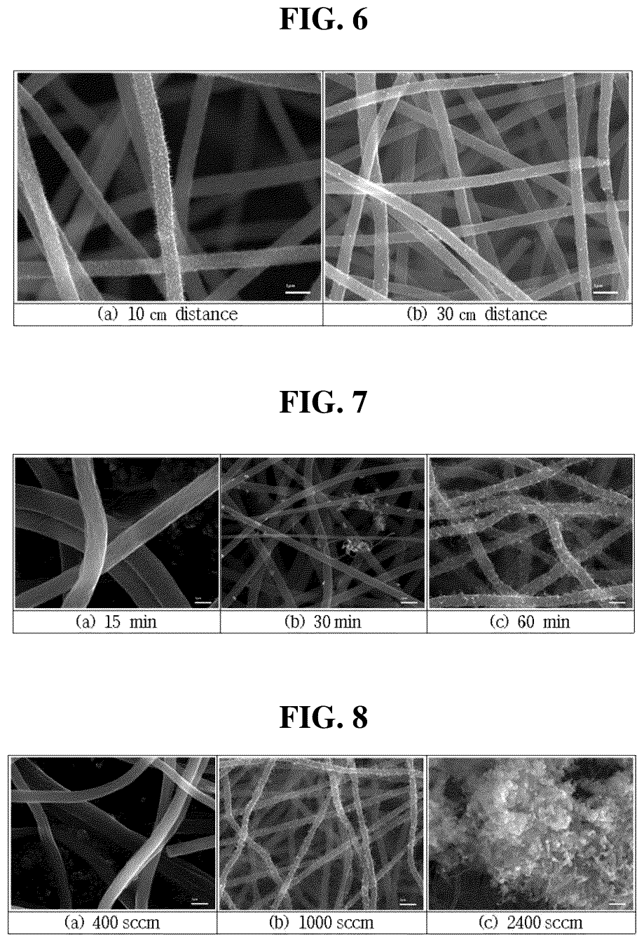

FIG. 6 is an SEM image of a carbon nanofiber-carbon nanotube composite manufactured by varying distance between a gas inlet and carbon nanotube fibers according to an embodiment of the present disclosure. Referring to FIG. 6, the shorter the distance between the gas inlet and the carbon nanofibers, the higher the density of the grown carbon nanotubes tended to be. In other words, the condition was confirmed that the closer the distance between the argon gas inlet and the carbon nanofibers, the higher the density and longer the length of the carbon nanotubes.

### Argon Gas Injection Time and Flow Rate

The aim was to determine the extent of carbon nanotube growth according to argon gas injection time. The trend was identified by proceeding for 15, 30, and 60 minutes. The argon gas was injected through ethanol, which is a carbon source.

FIG. 7 is an SEM image of a carbon nanofiber-carbon nanotube composite manufactured by varying gas injection time according to an embodiment of the present disclosure. Referring to FIG. 7, it may be seen that the length and density of the carbon nanotubes increase as the time increases. It may be confirmed that the carbon nanotubes hardly grew at a reaction time of 15 minutes, indicating that 30 minutes are required for the carbon nanotubes to grow.

In addition, the tendency was confirmed by controlling the flow rate of argon gas introduced through ethanol, which is a carbon source. As the flow rate of argon gas increased, the amount of ethanol introduced increased, and 400 sccm, 1,000 sccm, and 2,400 sccm were injected, respectively.

FIG. 8 is an SEM image of a carbon nanofiber-carbon nanotube composite manufactured by varying gas flow rate according to an embodiment of the present disclosure. Referring to FIG. 8, the carbon nanotubes hardly grew at a flow rate of 400 sccm, and a high growth rate was observed at 1,000 sccm. However, when a flow rate of 2,400 sccm was injected, carbon with a length of 200 nm or more was grown in an amorphous form. This shows that excessive injection of argon gas results in a decrease in quality even though the length of carbon nanotubes increases, and that they grow to an appropriate length at 1,000 sccm.

In other words, it was confirmed that the growth length of the carbon nanotubes tends to increase as the argon gas flow rate and time increase.

### (2) Carbon Nanofiber-Carbon Nanotube Microstructure and Catalyst Analysis

### Surface Morphology and Microstructure

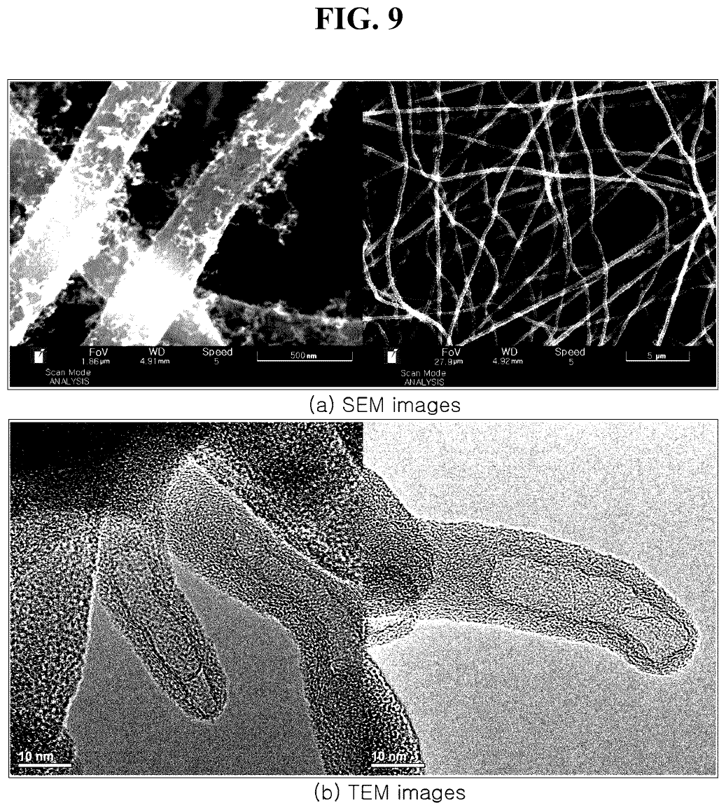

FIG. 9 is an image of a shape and a microstructure of a carbon nanofiber-carbon nanotube composite manufactured according to an embodiment of the present disclosure. Referring to FIG. 9, the SEM analysis results confirmed that carbon nanotubes with a thickness of about 10 to 20 nm were grown from carbon nanofibers with a thickness of about 150 to 200 nm. In addition, in order to confirm the microcrystalline structure of carbon nanofibers and carbon nanotubes, HR-TEM analysis was performed, and as a result, it was confirmed that the carbon nanotubes synthesized according to the example of the present disclosure grew to a length of about 50 to 100 nm.

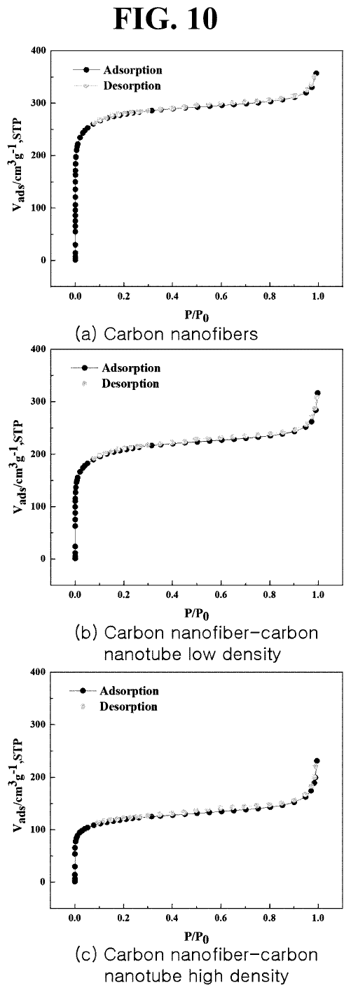

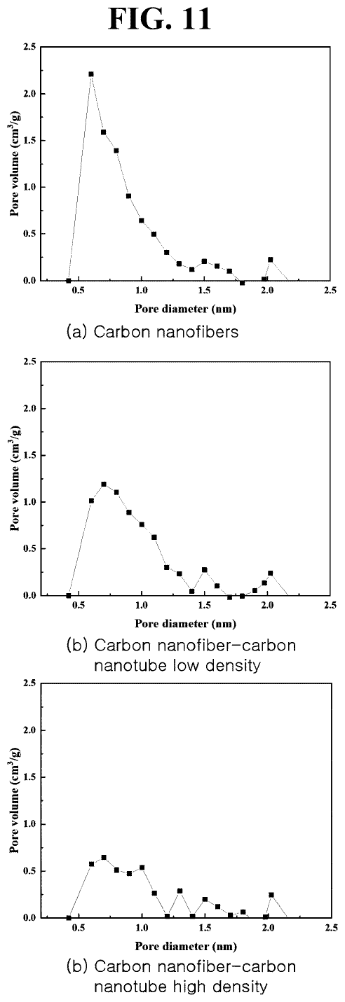

Next, the specific surface area and pore size of the carbon nanofiber-carbon nanotube composite were evaluated. FIG. 10 is a nitrogen adsorption/desorption isotherm curve of a carbon nanofiber-carbon nanotube composite manufactured according to an embodiment of the present disclosure. Looking at the adsorption/desorption isotherm curve of FIG. 10, it may be seen that as the density of the carbon nanotubes increases, the adsorption amount at a low pressure of a relative pressure of 0.1 or less decreases. The adsorption amount at a low pressure is due to the adsorption amount in micropores having a size of 2 nm or less, and it is determined that this graph trend is because the ratio of micropores on the surface of the carbon nanofibers gradually disappears, which is because the carbon nanotubes grew in these micropores. This may also be confirmed from the pore distribution curve of FIG. 11. In other words, it may be confirmed that the degree to which micropores of 2 nm or less contribute to the total adsorption amount decreases as carbon nanotubes grow.

In addition, as carbon nanotubes grow, differences occur in the adsorption/desorption curves, resulting in a hysteresis region, and this hysteresis occurring phenomenon indicates the existence of mesopores of 2 nm to 50 nm in size. It is thought that as carbon nanotubes grow, the space between these tubes creates these mesopores.

Meanwhile, the specific surface area, micropore volume, and average pore size of each material are shown in Table 1.

TABLE 1

| Samples | S_{BET} (m²/g) | V_{mic} (cm³/g) | Dₐₚ (nm) |
|---|---|---|---|
| Carbon nanofiber | 979.7 | 0.4411 | 2.2438 |
| Carbon nanofiber-carbon | 739.4 | 0.3268 | 2.3934 |
| nanotube low density | | | |
| Carbon nanofiber-carbon | 448.0 | 0.1627 | 2.8967 |
| nanotube high density | | | |
| Carbon nanofiber-carbon | 851.74 | 0.44 | 2.7948 |
| nanotube ultra high density | | | |

Referring to Table 1, as the density of carbon nanotubes increased, the micropore volume and average pore size decreased, and the specific surface area also decreased accordingly. In other words, it may be seen that micropores were created in the carbon nanofibers by solvent evaporation while fabricating nanofibers through electrospinning, and the carbon nanotubes grew in the micropores.

However, when the density of carbon nanotubes finally reached its highest, the specific surface area increased again. This indicates that as the carbon nanotubes grow, the pores become blocked and the specific surface area decreases, and then the specific surface area increases again due to the further grown carbon nanotubes.

In the present disclosure, it is preferable that the volume range of the micropores is 0 to 0.5 cm³/g, and the specific surface area is 300 to 900 m²/g. If the volume range of the micropores is out of the above range, it means that the carbon nanotubes did not grow well from the carbon nanofibers, which may be confirmed by the decrease in the density of the carbon nanotubes.

### Chemical Composition

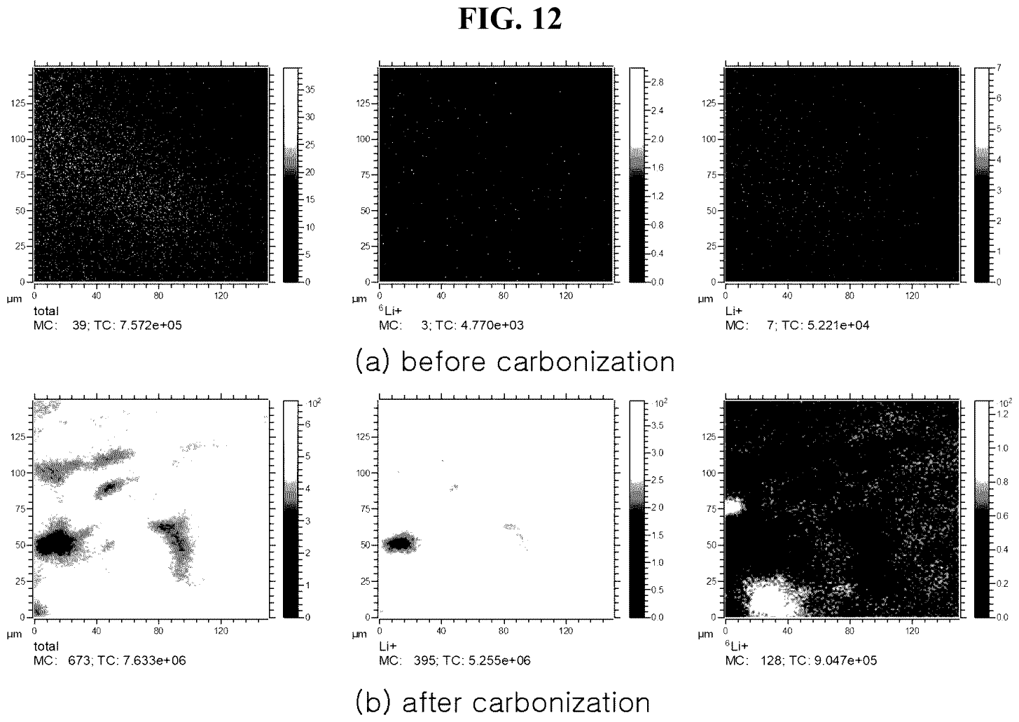

ToF-SIMS analysis was performed to confirm the distribution and presence of lithium used as a growth catalyst for carbon nanotubes. FIG. 12 illustrates ToF-SIMS analysis results of a carbon nanofiber-carbon nanotube composite manufactured according to an embodiment of the present disclosure. FIG. 12 (a) shows nanofibers before carbonization, and (b) shows carbon nanofibers after carbonization, and it was confirmed that lithium was present in both was evenly distributed overall. This indicates that Li was used as a catalyst in the synthesis of carbon nanotubes.

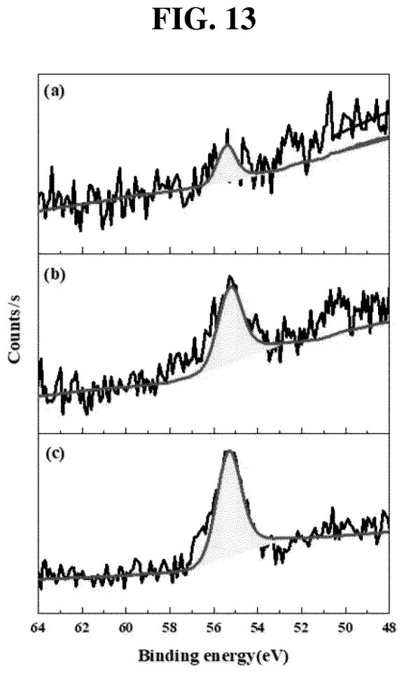

Next, XPS analysis was performed to confirm the presence and activation degree of the lithium catalyst in the carbon nanofiber-carbon nanotube composite. FIG. 13 illustrates XPS analysis results of a carbon nanofiber-carbon nanotube composite manufactured according to an embodiment of the present disclosure. Referring to FIG. 13, lithium spectra were found in both carbon nanofibers and carbon nanofiber-carbon nanotubes, and the spectra shown in FIG. 13 mainly correspond to lithium metal. It may be seen that the peak intensity becomes stronger as the carbon nanotubes grow. This shows that the lithium metal catalyst is activated as the heat treatment time and the supply of ethanol as a carbon source increase during the carbon nanotube growth.

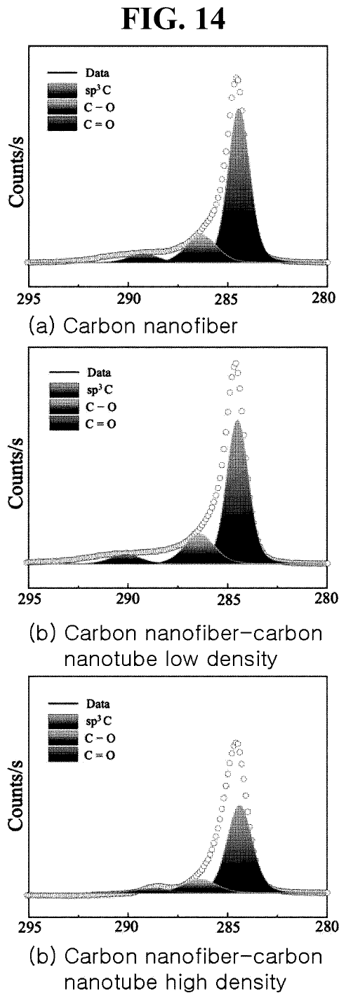

FIG. 14 is a carbon bonding peak of a carbon nanofiber-carbon nanotube composite manufactured according to an embodiment of the present disclosure. Referring to FIG. 14, it may be observed that the peak intensity of the C—C bond (285.2 eV) decreases as the carbon nanotubes grow. Compared to pure carbon nanofibers, the C—C peak of the sample with a high carbon nanotube density decreased by 43.7%. This peak, which represents the sp³ bond, is a peak that mainly appears in carbon nanofibers. This shows that the peak decreases as the carbon nanotubes grow.

In other words, it was confirmed that the carbon nanotubes were grown in an alkali metal.

### Electrical Conductivity

The electrical conductivity and surface resistance of carbon nanofibers and carbon nanofiber-carbon nanotubes were measured using a surface resistance meter, and the results are shown in Table 2. The applied current for the measurement was 100 mA.

TABLE 2

| | Resistance | Sheet resistance | Conductivity |
|---|---|---|---|
| Samples | (Ohm) | (Ohm/square) | (S cm⁻¹) |
| Carbon nanofiber | 11.9 | 48.3 | 2.07 |
| Carbon nanofiber-carbon | 11.3 | 45.9 | 2.17 |
| nanotube low density | | | |
| Carbon nanofiber-carbon | 4.9 | 20.2 | 4.95 |
| nanotube high density | | | |
| Carbon nanofiber-carbon | 2.7 | 11.9 | 8.40 |
| nanotube ultra high density | | | |

Referring to Table 2, the electrical conductivity of the composite material in which carbon nanotubes were grown on carbon nanofiber-carbon nanotubes was higher than that of pure carbon nanofibers, and it was confirmed that the higher the density of carbon nanotubes, the higher the electrical conductivity. This is because the growth of carbon nanotubes in the one-dimensional matrix of carbon nanofibers forms a network, increasing the total contact area and providing a short travel distance for ions and electrons.

In other words, it was confirmed that the electrical conductivity increased as carbon nanotubes grew on pure carbon nanofibers.

### Structural Analysis

Raman spectroscopy (micro Raman spectrometer) was performed to determine the degree of crystallization and graphitization of carbon nanofibers and carbon nanofiber-carbon nanotubes. The Raman spectrum of carbon shows two peaks corresponding to the D band and the G band, and are generally located at 1350 and 1580 cm⁻¹.

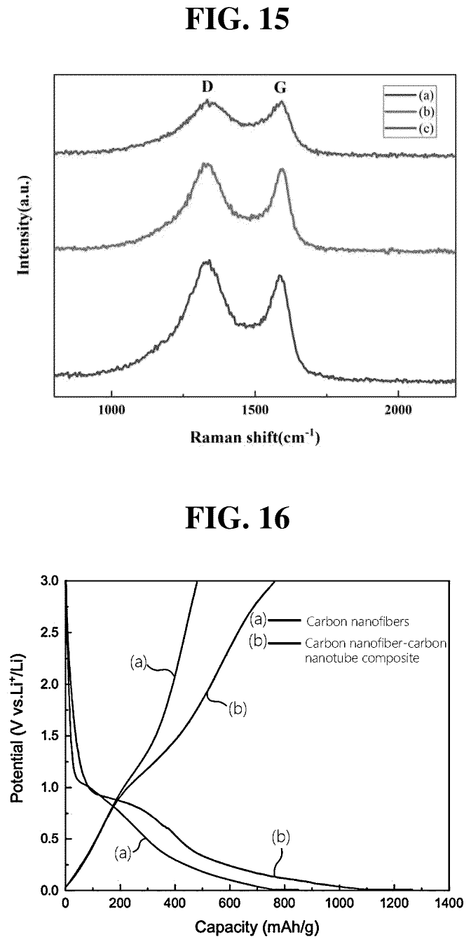

FIG. 15 is a Raman spectrum of a carbon nanofiber-carbon nanotube composite manufactured according to an embodiment of the present disclosure. Carbon nanofibers (a), carbon nanofiber-carbon nanotubes with a low carbon nanotube density (b), and carbon nanofiber-carbon nanotubes with a high carbon nanotube density (c) were measured by Raman spectroscopy and shown.

Referring to FIG. 15, D band and G band peaks were confirmed in all three materials, and it was confirmed that the degree of graphite crystallization increased with the growth of carbon nanotubes. The D band is mainly due to the disorder and imperfection of carbon crystals, such as nano graphene layers, defects, spaces within the CNT wall, and heteroatoms. The G band is related to the graphitic carbon structure. The Ip/IG band ratio is a major factor in evaluating the disorder and defects in the structure of carbon materials, and the higher the ID/IG ratio, the higher the degree of disorder and the more defects there are. In the case of single-walled carbon nanotubes (SWCNTs), the ID/IG ratio is low. The higher the carbon nanotube density of carbon nanofiber-carbon nanotubes, the smaller the ID/IG ratio, and the largest for pure carbon nanofibers. This is because the overall degree of crystallization increased as the density of carbon nanotubes increased.

### Electrochemical Performance

FIG. 16 is a first cycle charge/discharge curve of a lithium ion battery anode material including a carbon nanofiber-carbon nanotube composite manufactured according to an embodiment of the present disclosure.

Referring to FIG. 16, in terms of the density of carbon nanotubes, it may be confirmed that when there are 80 to 120 carbon nanotubes per 1 μm² of carbon nanofibers on the surface of the carbon nanotube-carbon nanofiber composite, the initial Coulombic efficiency is about 60.6%, which is about 5% better than the initial Coulombic efficiency of about 55.5% of the carbon nanofibers. This seems to be because the process of manufacturing the carbon nanofiber-carbon nanotube composite promoted the activation degree of lithium, resulting in an increase in the initial efficiency.

The difference may also be confirmed in the first cycle charge capacity. At a current density of 0.1 C, the charge capacity of the carbon nanofiber-carbon nanotube composite is about 1268.4 mAh/g, which is about 49% greater than the charge capacity of the carbon nanofibers, which is about 852.1 mAh/g.

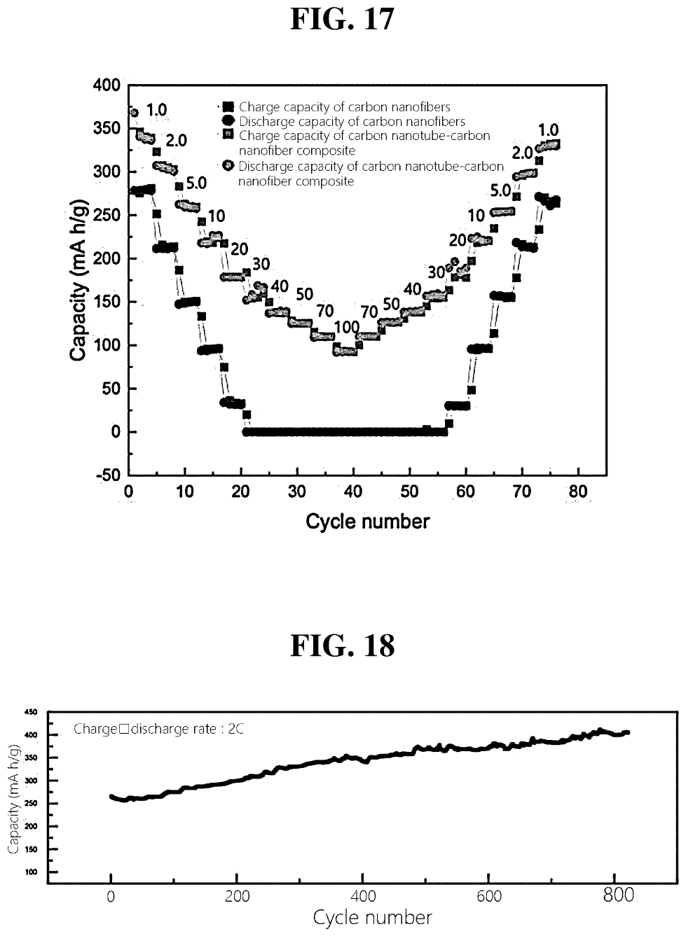

FIG. 17 illustrates ultra-high rate performance evaluation results of a lithium ion battery anode material including a carbon nanofiber-carbon nanotube composite manufactured according to an embodiment of the present disclosure.

Referring to FIG. 17, in order to confirm the stability of the carbon nanotube-carbon nanofiber composite and the carbon nanofibers, the current density was gradually increased from 1 C to 100 C, and then decreased to 1 C again. The carbon nanotube-carbon nanofiber composite exhibited discharge capacities of about 341, 309, 266, 226, 194, 163, 140, 126, 111, and 94 mAh/g at current densities of 1, 2, 5, 10, 20, 30, 40, 50, 70, and 100 C, respectively.

Meanwhile, conventional general carbon nanofibers showed discharge capacities of about 278, 223, 159, 107, 34, 5, 0.1, 0.1, 0.1, 0.1, 0.1 mAh/g. Stability was confirmed by showing that the original discharge capacity was recovered when the current density was increased to 100 C, which is a very high current density, and then decreased again to 1 C.

It may be confirmed that as the charge and discharge rate increases, the fading rate of the carbon nanofibers becomes increasingly larger than that of the carbon nanotube-carbon nanofiber composite. This seems to be because the carbon nanotubes grown on the carbon nanofibers form an electrical conduction path network that enables ions and electrons to flow well, thereby positively affecting the rate performance.

FIG. 18 is a discharge capacity graph at a charge/discharge rate of 2 C of a lithium ion battery anode material including a carbon nanofiber-carbon nanotube composite manufactured according to an embodiment of the present disclosure.

Referring to FIG. 18, it showed a discharge capacity of 260 mAh/g at the beginning, but the discharge capacity continued to increase as cycling progressed. It showed excellent life characteristics in which the discharge capacity increased to about 407 mA/g at about the 800th cycle, and it was confirmed that the capacity was similar to that at a 2 C rate in the ultra-high-speed performance evaluation.

As such, the present disclosure may easily grow carbon nanotubes from the surface of carbon nanofibers by simply manufacturing carbon nanofibers having an alkali metal precursor bonded to the surface through electrospinning, carbonizing, and then supplying a carbon source and performing heat treatment, thereby enabling mass production of carbon nanotube-carbon nanofiber composites. Furthermore, the present disclosure is characterized in that it specifies the steps of manufacturing a carbon nanotube-carbon nanofiber composite and controls the conditions to manufacture a carbon nanotube-carbon nanofiber composite in which the length and density of the carbon nanotubes are controlled and a uniform structure is formed.

In addition, since the carbon nanotube-carbon nanofiber composite of the present disclosure is manufactured using an alkali metal-based catalyst rather than a transition metal-based catalyst, the catalyst particles dissolve in water and may be easily removed, so that after the synthesis of the metal-free carbon nanotube-carbon nanofiber composite is completed, there is no need to go through a cleaning process such as acid treatment, thereby reducing environmental costs. In addition, the present disclosure is excellent in that it provides a carbon nanotube-carbon nanofiber composite having excellent durability because the carbon nanofiber and carbon nanotube are not separated due to the high bonding strength between the carbon nanofiber and the carbon nanotube by growing carbon nanotubes from carbon nanofibers using a nanocatalyst.

The above description is merely an exemplary description of the technical idea of the present disclosure, and those skilled in the art will appreciate that various modifications and variations may be made without departing from the essential characteristics of the present disclosure. Therefore, the embodiments disclosed in the present disclosure are not intended to limit the technical idea of the present disclosure, but rather to explain, and the scope of the technical idea of the present disclosure is not limited by these embodiments. The scope of protection of the present disclosure should be construed by the scope of the claims, and all technical ideas within the equivalent scope should be construed as being included in the scope of the rights of the present disclosure.

1. A method of manufacturing a carbon nanotube-carbon nanofiber composite, the method comprising:
a first step of preparing a spinning solution comprising an alkali metal precursor and a carbon-containing polymer;
a second step of electrospinning the spinning solution to manufacture carbon-containing polymer nanofibers having the alkali metal precursor bound to a surface;
a third step of heat-treating the carbon-containing polymer nanofibers to manufacture carbon nanofibers having the alkali metal precursor bound to a surface; and
a fourth step of heat-treating the carbon nanofibers while supplying a carbon source to manufacture a carbon nanotube-carbon nanofiber composite having carbon nanotubes bound to a surface,
wherein the fourth step comprises:
a carbon nanotube seed formation step of supplying the carbon source to the carbon nanofibers while heating in an inert gas atmosphere so that the alkali metal precursor is activated as an alkali metal nanocatalyst, and forming a carbon nanotube seed for growing into a carbon nanotube as the carbon source is bound to the surface of the carbon nanofibers by the nanocatalyst;
a first carbon nanotube growth step of resupplying the carbon source to the carbon nanofibers while heating in an inert gas atmosphere after the carbon nanotube seed formation step to grow carbon nanotubes on the surface of the carbon nanofibers;
a nanocatalyst activation step of supplying hydrogen gas after the first carbon nanotube growth step and further activating the nanocatalyst through reduction of the alkali metal nanocatalyst by the hydrogen gas supply; and
a second carbon nanotube growth step of resupplying the carbon source in an inert gas atmosphere after the nanocatalyst activation step to further grow carbon nanotubes,
thereby manufacturing a carbon nanotube-carbon nanofiber composite having 80 to 120 carbon nanotubes per 1 μm² of the carbon nanofibers on the surface of the carbon nanotube-carbon nanofiber composite.

2. The method according to claim 1, wherein, in the fourth step,
the carbon source is vaporized from a liquid carbon source, supplied together with the inert gas, and then heat-treated at 600 to 700° C.

3. The method according to claim 1, wherein a length of the carbon nanotubes in the carbon nanotube-carbon nanofiber composite is 30 to 120 nm.

4. The method according to claim 1, wherein the alkali metal precursor is selected from the group consisting of a Li precursor, a Na precursor, a K precursor, and mixtures thereof.

5. The method according to claim 1, wherein the carbon-containing polymer is selected from the group consisting of polyacrylonitrile (PAN), polyvinyl acetate (PVA), polyvinyl pyrrolidone (PVP), polycarbonate (PC), polyvinylchloride (PVC), cellulose, cellulose acetate, and mixtures thereof.

6. A carbon nanotube-carbon nanofiber composite manufactured according to claim 1.

7. A method of manufacturing a carbon nanotube-carbon nanofiber composite, the method comprising:
a first step of preparing a spinning solution comprising an alkali metal precursor and a carbon-containing polymer;
a second step of electrospinning the spinning solution to manufacture carbon-containing polymer nanofibers having the alkali metal precursor bound to a surface;
a third step of heat-treating the carbon-containing polymer nanofibers to manufacture carbon nanofibers having the alkali metal precursor bound to a surface; and
a fourth step of heat-treating the carbon nanofibers while supplying a carbon source to manufacture a carbon nanotube-carbon nanofiber composite having carbon nanotubes bound to a surface.

8. A method of manufacturing a branched fine carbon nanofiber-carbon nanofiber composite, the method including:
a first step of preparing a spinning solution comprising an alkali metal precursor and a carbon-containing polymer;
a second step of electrospinning the spinning solution to manufacture carbon-containing polymer nanofibers having the alkali metal precursor bound to a surface;
a third step of heat-treating the carbon-containing polymer nanofibers to manufacture carbon nanofibers having the alkali metal precursor bound to a surface; and
a fourth step of heat-treating the carbon nanofibers while supplying a carbon source to manufacture a branched fine carbon nanofiber-carbon nanofiber composite having branched fine carbon nanofibers bound to a surface.

9. A method of manufacturing a branched fine carbon nanofiber-carbon nanofiber composite, the method including:
a first step of preparing a spinning solution comprising an alkali metal precursor and a carbon-containing polymer;
a second step of electrospinning the spinning solution to manufacture carbon-containing polymer nanofibers having the alkali metal precursor bound to a surface;
a third step of heat-treating the carbon-containing polymer nanofibers to manufacture carbon nanofibers having the alkali metal precursor bound to a surface; and
a fourth step of heat-treating the carbon nanofibers while supplying a carbon source to manufacture a branched fine carbon nanofiber-carbon nanofiber composite having branched fine carbon nanofibers bound to a surface,
wherein the fourth step comprises:
a branched fine carbon nanofiber seed formation step of supplying the carbon source to the carbon nanofibers while heating in an inert gas atmosphere so that the alkali metal precursor is activated as an alkali metal nanocatalyst, and forming a branched fine carbon nanofiber seed for growing into branched fine carbon nanofibers as the carbon source is bound to the surface of the carbon nanofibers by the nanocatalyst;
a first branched fine carbon nanofiber growth step of resupplying the carbon source to the carbon nanofibers while heating in an inert gas atmosphere after the branched fine carbon nanofiber seed formation step to grow branched fine carbon nanofibers on the surface of the carbon nanofibers;
a nanocatalyst activation step of supplying hydrogen gas after the first branched fine carbon nanofiber growth step and further activating the nanocatalyst through reduction of the alkali metal nanocatalyst by the hydrogen gas supply; and
a second branched fine carbon nanofiber growth step of resupplying the carbon source in an inert gas atmosphere after the nanocatalyst activation step to further grow branched fine carbon nanofibers,
thereby manufacturing a branched fine carbon nanofiber-carbon nanofiber composite having 80 to 120 branched fine carbon nanofibers per 1 μm² of the carbon nanofibers on the surface of the branched fine carbon nanofiber-carbon nanofiber composite.
